(19) United States
(12) Patent Application Publication
(10) Pub. No.: US 2017/0303181 A1
(43) Pub. Date: Oct. 19, 2017

(54) CELL CHANGE MANAGEMENT DURING VOICE CALL ESTABLISHMENT

(71) Applicant: QUALCOMM Incorporated, San Diego, CA (US)

(72) Inventors: Vagish Gupta, Hyderabad (IN); Liangchi Hsu, San Diego, CA (US); Ansah Ahmed Sheik, Eluru (IN); Vikas Gulati, Hyderabad (IN)

(21) Appl. No.: 15/098,050

(22) Filed: Apr. 13, 2016

(51) Int. Cl. H04W 36/36

(52) U.S. Cl. CPC H04W 36/36

(57) ABSTRACT

Wireless communication at a user equipment (UE) is described. In some cases, a UE may determine that a voice call is about to be setup or in the process of being setup with a cell that supports voice calls. While the voice call is pending, the UE may be motivated to connect to a cell that does not support voice calls. The UE may recognize that the cell does not support voice calls and refrain from connecting to the cell until after the voice call setup, and/or the voice call itself, has completed.

### BACKGROUND

The following relates generally to wireless communication, and more specifically to cell change management during voice call establishment.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may each be referred to as a user equipment (UE).

A UE may be capable of communicating with base stations or cells using a number of different wireless technologies which support a variety of different services. For example, certain types of wireless technologies may support voice services while others do not. In some cases, a UE that is in the process of setting up a voice call with a cell that supports voice calls may (e.g., due to a wireless technology prioritization scheme) attempt to connect to a cell that does not support voice calls. Upon connection to the cell that does not support voice calls, the UE may recognize that the cell does not support voice calls and change connections to a cell that does support voice calls. Connecting to a cell that does not support voice calls may unnecessarily delay service to the voice call, which in turn may cause the voice call setup to fail. Improved methods of mobility are desired.

### SUMMARY

The described techniques relate to improved methods, systems, devices, or apparatuses that support cell change management during voice call establishment. Generally, the described techniques provide for mobility management during voice calls. In some cases, a user equipment (UE) may determine that a voice call is about to be setup or in the process of being setup with a cell that supports voice calls. While the voice call is pending, the UE may be motivated (e.g., internally or externally) to connect to a cell that does not support voice calls. The UE may recognize that the cell does not support voice calls and refrain from connecting to the cell until after the voice call setup, or the voice call itself has completed.

A method of wireless communication at a UE is described. The method may include determining, while the UE is in radio resource control (RRC) idle mode or in RRC connected mode with a first cell that supports voice calls, that the UE is to participate in a voice call setup operation, determining that the UE is to attempt to establish a connection to a second cell while the voice call setup operation is in progress, wherein voice calls are unsupported by the second cell, and preventing, by the UE, establishment of the connection to the second cell while the voice call setup operation is in progress based at least in part on voice calls being unsupported by the second cell.

An apparatus for wireless communication at a UE is described. The apparatus may include means for determining, while the UE is in RRC idle mode or in RRC connected mode with a first cell that supports voice calls, that the UE is to participate in a voice call setup operation, means for determining that the UE is to attempt to establish a connection to a second cell while the voice call setup operation is in progress, wherein voice calls are unsupported by the second cell and means for preventing, by the UE, establishment of the connection to the second cell while the voice call setup operation is in progress based at least in part on voice calls being unsupported by the second cell.

A further apparatus is described. The apparatus may include a processor, memory in electronic communication with the processor, and one or more instructions stored in the memory. The one or more instructions may be operable to cause the processor to determine, while the UE is in RRC idle mode or in RRC connected mode with a first cell that supports voice calls, that the UE is to participate in a voice call setup operation, determine that the UE is to attempt to establish a connection to a second cell while the voice call setup operation is in progress, wherein voice calls are unsupported by the second cell and prevent, by the UE, establishment of the connection to the second cell while the voice call setup operation is in progress based at least in part on voice calls being unsupported by the second cell.

A non-transitory computer readable medium for wireless communication at a UE is described. The non-transitory computer-readable medium may include one or more instructions to cause a processor to determine, while the UE is in RRC idle mode or in RRC connected mode with a first cell that supports voice calls, that the UE is to participate in a voice call setup operation, determine that the UE is to attempt to establish a connection to a second cell while the voice call setup operation is in progress, where voice calls are unsupported by the second cell and prevent, by the UE, establishment of the connection to the second cell while the voice call setup operation is in progress based on voice calls being unsupported by the second cell.

In some examples of the method, apparatus, or non-transitory computer-readable medium described above, preventing establishment of the connection comprises preventing the attempt to establish the connection or preventing successful completion of the attempt to establish the connection. Some examples of the method, apparatus, or non-transitory computer-readable medium described above may further include processes, features, means, or instructions for participating in the voice call setup operation with the first cell, where preventing establishment of the connection to the second cell includes preventing establishment of the connection to the second cell until after a voice call associated with the voice call setup operation is finished.

Some examples of the method, apparatus, or non-transitory computer-readable medium described above may further include processes, features, means, or one or more instructions for determining that radio access bearers (RABs) are assigned to the UE, where determining that the UE is to attempt to establish the connection to the second cell occurs prior to the determination of the RABs assignment. In some examples of the method, apparatus, or non-transitory computer-readable medium described above, preventing establishment of the connection to the second cell comprises preventing at least one of selection, reselection, redirection, or handover (HO) to the second cell.

In some examples of the method, apparatus, or non-transitory computer-readable medium described above, preventing establishment of the connection to the second cell comprises receiving, while the UE is in an RRC connected mode, an indication to change connections from the first cell that supports CS voice calls to the second cell. Some examples of the method, apparatus, or non-transitory computer-readable medium described above may further include processes, features, means, or one or more instructions for refraining from changing connections.

In some examples of the method, apparatus, or non-transitory computer-readable medium described above, the indication to change connections comprises at least one of an RRC connection release message comprising a redirection indication or a packet switched (PS) HO message. In some examples of the method, apparatus, or non-transitory computer-readable medium described above, preventing establishment of the connection to the second cell comprises assigning a selection or reselection priority of the second cell that does not support voice calls to be lower than a selection or reselection priority of one or more cells that do support voice calls.

In some examples of the method, apparatus, or non-transitory computer-readable medium described above, preventing establishment of the connection to the second cell comprises ignoring one or more signals associated with the second cell that do not support voice calls. In some examples of the method, apparatus, or non-transitory computer-readable medium described above, ignoring the one or more signals comprises at least one of refraining from performing measurements of the one or more signals or refraining from using measurements of the one or more signals. In some examples of the method, apparatus, or non-transitory computer-readable medium described above, preventing establishment of the connection to the second cell comprises delaying, while the UE is in RRC idle mode, an opportunity to re-select the second cell until after a connection has been established with a cell that supports voice calls.

Some examples of the method, apparatus, or non-transitory computer-readable medium described above may further include processes, features, means, or one or more instructions for determining that PS voice calls are unsupported by the second cell, where preventing establishment of the connection to the second cell based on voice calls being unsupported by the second cell preventing establishment of the connection to the second cell based at least in part on determining that PS voice calls are unsupported by the second cell.

In some examples of the method, apparatus, or non-transitory computer-readable medium described above, determining that PS voice calls are unsupported by the second cell comprises receiving an indication of voice call capabilities of the second cell in a system information (SI) message. In some examples of the method, apparatus, or non-transitory computer-readable medium described above, determining that PS voice calls are unsupported by the second cell comprises accessing information stored by the UE, where the information is indicative of voice call capabilities of the second cell.

In some examples of the method, apparatus, or non-transitory computer-readable medium described above, preventing establishment of the connection to the second cell comprises updating, by the UE, one or more parameters associated with reselection to prevent establishment of the connection to the second cell until after a connection has been established with a cell that supports voice calls. In some examples, a voice call corresponding to the voice call setup operation is a circuit switched (CS) voice call or a PS voice call.

### BRIEF DESCRIPTION OF THE DRAWINGS

FIG. 1 illustrates an example of a wireless communications system that supports cell change management during voice call establishment in accordance with aspects of the present disclosure.

FIG. 2 illustrates an example of a wireless communications system that supports cell change management during voice call establishment in accordance with aspects of the present disclosure.

FIG. 3 illustrates an example of a flow chart that supports cell change management during voice call establishment in accordance with aspects of the present disclosure.

FIG. 4 illustrates an example of a process flow that supports cell change management during voice call establishment in accordance with aspects of the present disclosure.

FIG. 5 illustrates an example of a process flow in a system that supports cell change management during voice call establishment in accordance with aspects of the present disclosure.

FIGS. 6 through 8 show block diagrams of a wireless device that supports cell change management during voice call establishment in accordance with aspects of the present disclosure.

FIG. 9 illustrates a block diagram of a system including a user equipment (UE) that supports cell change management during voice call establishment in accordance with aspects of the present disclosure.

FIGS. 10 through 12 illustrate methods for cell change management during voice call establishment in accordance with aspects of the present disclosure.

### DETAILED DESCRIPTION

A user equipment (UE) may autonomously prevent connection to cells that do not support voice calls when a voice call setup operation is in progress and/or is about to be initiated. The UE may be in idle mode or connected to a cell that supports voice calls when a voice call setup is initiated (e.g., by the network, in a mobile terminated (MT) voice call, or by the UE, in a mobile originated (MO) voice call). In response, the UE may begin to establish a voice call with a cell that supports voice calls (e.g., a cell that operates according to 2G or 3G wireless technology). Prior to or during the voice call setup, the UE may be prompted to connect to a cell that does not support voice calls (e.g., a cell that operates according to Long Term Evolution (LTE) which does not support voice calls). For example, the UE may receive a message from the network instructing the UE to connect to the cell that does not support voice calls. Rather than following the instructions, the UE may refrain from attempting to connect, or abort an attempt to connect, to the cell that does not support voice calls and proceed with, or initiate, voice call setup operations with the cell that does support voice calls. The UE may continue to prevent connection to the cell that does not support voice calls until after the voice call has ended.

In some cases, the UE may prevent connection to the cell that does not support voice calls by abandoning, in between voice calls that occur within a threshold amount of time of each other, fast return to the cell that does not support voice calls. In other cases, the UE may ignore cells that do not support voice calls when evaluating potential cells for selection or reselection. For example, signals from cells that do not support voice calls may be ignored when the UE makes signal measurements that are used for selection or reselection decisions. The UE may either refrain from measuring the signals, or refrain from taking the signals into account when evaluating candidates for selection or reselection. In some examples, the UE may change a reselection parameter so that connection to a cell that does not support voice calls is delayed until after the voice call has been setup with the cell that does support voice calls. For instance, the UE may change (e.g., increase) the amount of time a cell is to be monitored before the cell is allowed to be a candidate for reselection, thereby delaying reselection to cells that do not support voice calls.

In some cases, the UE may receive, during the voice call setup, a message from the network, indicating that the UE is to change connections from the cell that supports voice calls to a cell that does not support voice calls. For example, the UE may receive a radio resource control (RRC) connection release message that includes a redirection indication to the cell that does not support voice calls. In such an instance, the UE may act as if the redirection information is absent from the RRC connection release message and refrain from redirecting to the cell that does not support voice calls. In another example, the UE may receive a handover message (e.g., a packet switched (PS) handover message) from the network indicating that the UE is to handover to a cell that does not support voice calls. In such a scenario, the UE may behave as if the handover message was not received and refrain from handing over to the cell that does not support voice calls.

In some cases, the UE may determine the voice call capabilities of a cell prior to implementing the prevention techniques described herein. For example, the UE may determine if the cell supports circuit switched (CS) voice calls or packet switched (PS) voice calls. If the cell supports either type of voice call, the UE may refrain from implementing the preventing techniques described herein. If the cell does not support either type of voice call, the UE may employ the preventing techniques described herein. A UE may determine the voice call capabilities of a cell via information received from the cell (e.g., via an indication from the cell conveyed in a system information block (SIB) such as system information block type 1 (SIB1)). Or the UE may determine the voice call capabilities of the cell by accessing voice call capability information for the cell, as previously obtained and stored by the UE.

Features of the disclosure introduced above are further described below in the context of a wireless communications system. Specific example methods and apparatus are then described for cell change management. These and other features of the disclosure are further illustrated by and described with reference to apparatus diagrams, system diagrams, and flowcharts that relate to the adjustment of downlink and uplink scheduling for transmission opportunities.

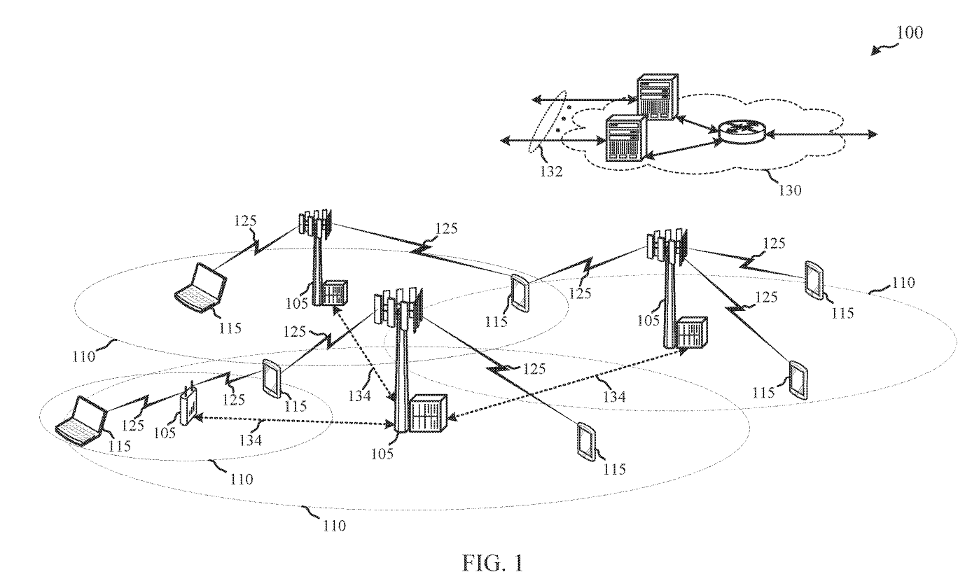

FIG. 1 illustrates an example of a wireless communications system 100 in accordance with various aspects of the present disclosure. The wireless communications system 100 includes base stations 105, UEs 115, and a core network 130. The wireless communications system 100 may be a heterogeneous wireless communication system that includes base stations 105 (or cells) that operate according to different wireless technologies or radio access technologies (RATs). In one example, a number of the base stations 105 may operate according to 2G or 3G wireless technology and a number of base stations 105 may operate according to LTE/LTE-Advanced (LTE-A) wireless technology. Thus, the 2G/3G base stations may provide areas of 2G/3G coverage and the LTE base stations may provide areas of LTE coverage. In some cases, LTE base stations may be deployed in small pockets embedded within 2G and 3G coverage so that a UE may select between LTE service and 2G/3G service. Each of the base stations 105 may be supported by a corresponding network that operates according to the same wireless technology.

Different RATs may support different types of services and may feature different types of connections (e.g., CS connections versus PS connections). For instance, some RATs may be capable of supporting voice calls and some RATs may not be capable of supporting voice calls. Thus, a first base station 105 (e.g., or associated cell) may operate according to a wireless technology that does not support voice calls at all (e.g., LTE), a second base station 105 (e.g., or associated cell) may operate according to a wireless technology that supports PS voice calls (e.g., LTE supporting IP Multimedia Subsystem (IMS) or Voice-over LTE (VoLTE)), and a third base station 105 (e.g., or associated cell) may operate according to a wireless technology that supports CS voice calls (e.g., 2G or 3G). According to the techniques described herein, a UE 115 that is setting up a voice call with a cell that supports voice calls may prevent connection to a cell that does not support voice calls until after the voice call setup is established, and/or until the voice call itself is finished. Such prevention may reduce delays in setting up voice calls, which in turn may reduce the number of dropped voice calls.

Base stations 105 may wirelessly communicate with UEs 115 (e.g., using various RATs or wireless technologies) via one or more base station antennas. Each base station 105 may provide communication coverage for a respective geographic coverage area 110. Each base station 105 may provide communication coverage for a macro cell, a small cell, or other types of cell. The term “cell” is a 3rd Generation Partnership Project “3GPP” term that can be used to describe a base station, a carrier or component carrier associated with a base station, or a coverage area (e.g., sector, etc.) of a carrier or base station, depending on context. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, wireless communication UE apparatus, or like terminology. A UE 115 may also be a cellular phone, a wireless modem, a handheld device, a personal computer, a tablet, a personal electronic device, an machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. A base station 105 may also be referred to as an access point (“AP”), a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A UE 115 may perform a cell selection procedure to establish a connection with a base station 105 or to reselect a neighboring cell with better performance or higher priority. Cell selection and/or reselection may occur when the UE 115 is in a radio resource configuration (RRC) idle mode. The selection procedure may include a determination of whether a candidate cell meets minimum selection criteria (S-criteria) and to select among several available cells. S-criteria may include reference signal received power (RSRP), reference signal received quality (RSRQ), a minimum signal power threshold, a public land mobile network (PLMN) priority offset, a maximum transmit power, and/or a hysteresis parameter (e.g., to avoid ping-ponging between cells). Each cell may transmit its own minimum RSRP, cell priority, and maximum transmit power over a system information block (SIB) such as SIB1, for example, and may convey corresponding values for neighboring cells in system information block type 4 (SIB4) and system information block type 5 (SIB5), for example. A UE 115 may measure signals of candidate cells to determine the S-criteria.

A UE 115 may begin a cell selection procedure by identifying a set of available PLMNs, selecting the highest priority PLMN (e.g., the home PLMN), and then selecting the best available cell in the selected PLMN. If a UE 115 is camped on a cell, it may periodically perform a cell search and rank available cells based on the S-criteria. If the UE 115 determines that a non-serving neighbor cell has qualifying S-criteria (e.g., the signal strength is sufficiently high), and the rank of the neighbor cell is higher than the rank of the serving cell, then the UE may reselect to the higher rank cell. If the UE 115 performs the cell search while connected to a visitor public land mobile network (VPLMN), it may use the priority offset to give preference to a home PLMN (e.g., or another higher priority PLMN).

In some cases, the type of wireless technology used by a candidate selection/reselection cell may be a factor in the selection/reselection process for a UE. For example, certain wireless technologies (e.g., data-centric wireless technologies that are primarily used for high speed data services, such as LTE) may be prioritized over other wireless technologies (e.g., voice-centric wireless technologies such as 2G/3G). Thus, a UE 115 may attempt to connect to a cell of a higher priority wireless technology (e.g., via selection or reselection) even if the cell is not capable of supporting the type of operation the UE 115 is interested in. For example, a UE 115 that has a voice call waiting to be setup may attempt to connect to a cell that does not support voice calls because the cell that does not support voice calls is prioritized over cells that do support voice calls. Such a scenario may occur when the network corresponding to the cell or the UE 115 is unaware that a voice call setup is about to be initiated or is in progress, for example.

According to the techniques described herein, a UE 115 may opt to ignore the prioritization of the wireless technologies by preventing connection to the higher priority cell and connecting to a lower priority cell that supports the desired operation (e.g., voice calls). Alternatively, the UE 115 may effectively remove cells that do not support voice calls from selection/reselection candidacy by modifying selection/reselection prioritization. For example, the UE 115 may reduce the priority of cells that do not support voice calls (e.g., during a voice call setup). In some cases, the UE 115 may prevent selection/reselection to cells that do not support voice calls by refraining from making measurements of signals conveyed on frequencies of cells that do not support voice calls. In other cases, the UE 115 may make the measurements but may refrain from considering the measurements when evaluating the S-criteria for selection/reselection.

When a UE 115 is in RRC connected mode the UE 115 may change cell connections by performing handover from one cell to another cell. For example, a UE 115 may be moving away from a cell that is serving the UE 115 and experience a reduction in connection quality. The UE 115 may recognize the reduction in connection quality and determine that a candidate cell is capable of providing better support than the current serving cell. Accordingly, the UE 115 may handover to the target cell. The UE 115 may be aware of candidate cells for handover due to measurements taken by the UE 115. For example, the UE 115 may measure the RSRP of the current serving (source) cell and/or determine the received signal strength indicator (RSSI) of candidate cells. The UE 115 may report the measurements to the network. Based on the measurements, the network may determine that the UE 115 should handover from the source cell to a target cell. The network may indicate this determination to the UE 115 by sending a handover message (e.g., a PS handover message) to the UE.

A UE 115 may perform handover when an interface (e.g., an X2 interface) exists between the source cell and the target cell. If an interface does not exist between the source cell and the target cell, the UE 115 may perform redirection. For example, the UE 115 may be directed, via a redirection message (e.g., an RRC connection release message) from the network, to release its connection with the source cell and redirect itself to a target cell indicated by the redirection message (e.g., via carrier frequency or cell identification (ID)).

A UE 115 may be in RRC idle mode or RRC connected mode. When a UE 115 is in RRC idle mode, there is no RRC context in the radio-access network and the UE 115 does not belong to a specific cell. When the UE 115 is in RRC connected mode, an RRC context is established and the cell to which the UE 115 belongs is known. A UE 115 may be in different RRC states while in RRC connected mode. For example, the UE 115 may be in dedicated channel (DCH) state (e.g., also referred to as CELL_DCH), paging channel (PCH) state (e.g., also referred to as CELL PCH), or forward access channel (FACH) state (e.g., also referred to as CELL_FACH). The RRC state of a UE 115 may refer to various different phases in which the UE 115 may be after RRC connection setup and before RRC release. Each RRC state (e.g., and RRC mode) may be associated with particular mobility procedures, physical channels, transport channels, and/or logical channels. For example, a UE 115 may perform mobility procedures such as cell selection and/or reselection while in RRC idle mode, FACH state, and/or PCH state. A UE 115 may perform mobility procedures such as handover and/or redirection while in DCH state, for example. The techniques described herein may be performed by a UE 115 in RRC idle mode or in any RRC state in RRC connected mode.

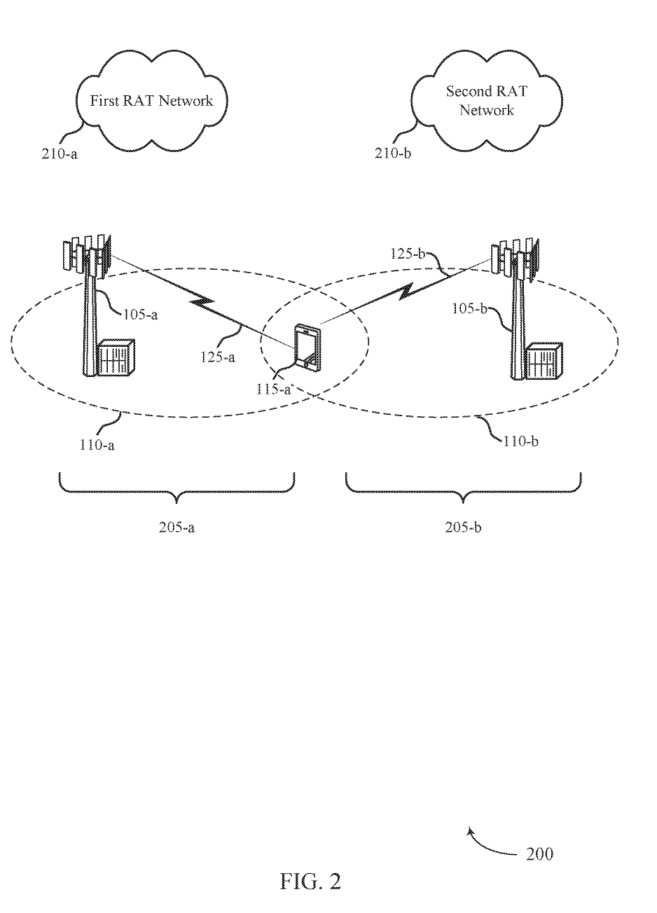

FIG. 2 illustrates an example of a wireless communications system 200 for cell change management during voice call establishment in accordance with various aspects of the present disclosure. Wireless communications system 200 may include base station 105-a and UE 115-a, which may be examples of a base station 105 described with reference to FIG. 1. Each base station 105 may provide communication coverage for a macro cell, a small cell, or other types of cell. As explained above, the term “cell” is a 3GPP term that can be used to describe a base station, a carrier or component carrier associated with a base station, or a coverage area (e.g., sector, etc.) of a carrier or base station, depending on context. Thus, base station 105-a and corresponding coverage area 110-a may be part of a cell 205-a that supports voice calls (e.g., cell 205-a may operate according to 2G or 3G wireless technology). Base station 105-b and corresponding coverage area 110-b may be part of a cell 205-b that does not support voice calls (e.g., cell 205-b may operate according to LTE wireless technology). Each base station 105 may be belong to, or be supported by, a corresponding network that operates according to the same wireless technology as the base station 105. For example, base station 105-a may belong to a first RAT network 210-a (e.g., a 2G or 3G network) and base station 105-b may belong to a second RAT network 210-b (e.g., an LTE network).

Base station 105-a may provide service (e.g., via wireless communication link 125-a) to mobile devices within coverage area 110-a and base station 105-b may provide service (e.g., via wireless communication link 125-b) to mobile devices within coverage area 110-b. The coverage area 110-a for cell 205-a may overlap or intersect with the coverage area 110-b for cell 205-b. Thus, a mobile device (e.g., UE 115) located at the intersection of the two coverage areas 110 may be capable of connecting to either of the two cells 205. A mobile device in such a scenario may select which of the candidate cells 205 to connect to for service. According to the techniques described herein, the mobile device may select a candidate cell 205 for connection based on whether or not a voice call setup is upcoming, imminent or in progress and based on the voice call capabilities of the candidate cells 205.

In one example, UE 115-a may be at the intersection of cell 205-a and cell 205-b when UE 115-a initiates or receives a voice call (e.g., a CS voice call or a PS voice call). Before UE 115-a can setup the voice call or connect to cell 205-a, (e.g., before radio access bearers (RABs) are assigned to UE 115-a for the voice call, or while the voice call is still in the non-access stratum (NAS) initiation phase), UE 115-a may determine that connection to cell 205-b should be attempted (e.g., UE 115-a may determine that selection, reselection, redirection, or handover to cell 205-b should occur). The determination may be made autonomously by UE 115-a or in response to a message from the first RAT network 210-a. Rather than blindly acting on the determination, UE 115-a may detect that the voice call setup is upcoming, imminent or in progress with cell 205-a and opt out of attempting to connect to cell 205-b. That is, UE 115-a may prevent establishment of a connection to cell 205-b. UE 115-a may prevent connection by not attempting to connect in the first place, or, if the attempt is already in progress, by abandoning the attempt before the attempt can be successfully completed.

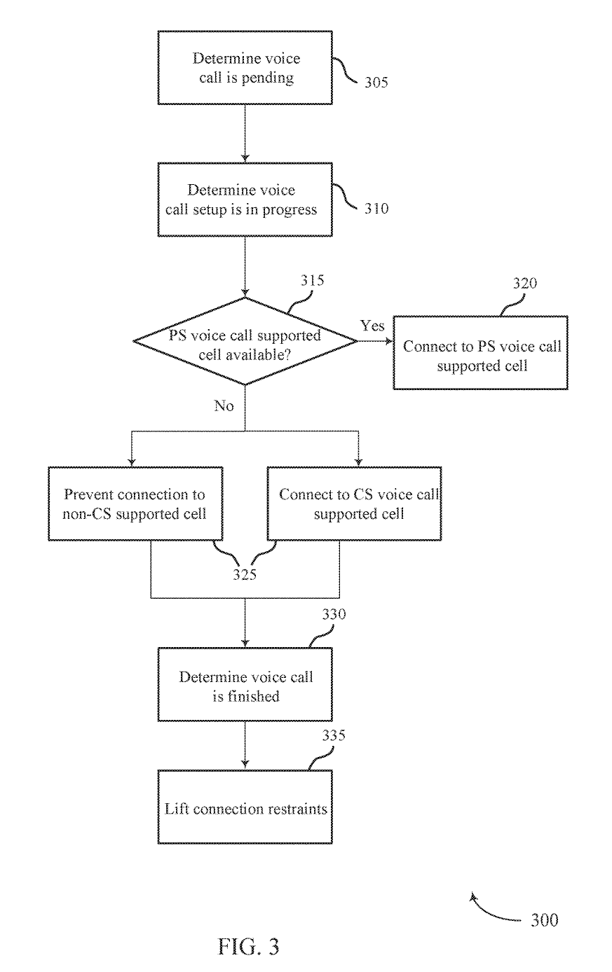

FIG. 3 illustrates an example of a flow chart 300 for cell change management during voice call establishment in accordance with various aspects of the present disclosure. Flow chart 300 may represent aspects of techniques performed by a UE 115 as described with reference to FIGS. 1 and 2. For example, a UE 115 may perform the actions of flow chart 300 to prevent, during voice call setup with a cell that support voice calls, establishment of a connection to a cell that does not support voice calls. A UE 115 performing the actions of flow chart 300 may initially be in RRC connected mode (e.g., DCH, FACH, or PCH state) or in RRC idle mode.

At 305, the UE 115 may determine that a voice call is pending. For example, the UE 115 may detect that an MO voice call (e.g., a voice call initiated by the UE 115) is pending, or that an MT voice call (e.g., a voice call initiated by the first RAT network 210-a) is pending. At 310, the UE 115 may determine that the voice call setup is in progress. For example, the UE 115 may determine that the first RAT network 210-a is in the process of assigning RABs to the UE 115 for the voice call (e.g., the voice call is still in the NAS initiation stage). At 315, the UE 115 may determine if a cell that supports PS voice calls (e.g., via IMS or VoLTE) is available for connection. For example, the UE 115 may receive system information from a candidate cell (e.g., via an SIB such as SIB1) that indicates the voice call capabilities of the candidate cell. If the information indicates that the candidate cell supports PS voice calls, the UE 115 may, at 320, connect to the candidate cell to setup and complete the voice call (e.g., cells that support PS voice calls may be prioritized over cells that support CS voice calls). The connection may be part of a selection procedure, a reselection procedure, a redirection procedure, or a handover procedure. In some cases, the UE 115 may use stored information (e.g., originally obtained via received system information) to determine if the candidate cell supports PS voice calls.

If the candidate cell does not support PS voice calls, the UE 115 may, at 325, connect to a cell that supports CS voice calls (e.g., finish the voice call setup) and/or prevent connection to a cell that does not support CS voice calls. The UE 115 may prevent connection to the cell that does not support CS voice calls by preventing an attempt to establish a connection, or by abandoning an attempt to establish a connection that has already been started. In some cases, the UE 115 may prevent connection by preventing selection or reselection to cells that do not support voice calls. For example, the UE 115 may refrain from making cell selection/reselection measurements on signals from cells that do not support voice calls. Or, the UE 115 may make the measurements but refrain from using (e.g., evaluating) the measurements for selection/reselection. In other words, UE 115 may remove cells that do not support voice calls from selection/reselection candidacy. In another example, the UE 115 may delay the candidacy of cells that do not support voice calls by adjusting, or updating, one or more parameters associated with selection and/or reselection. For example, the UE 115 may increase the amount of time a cell that does not support voice calls must be monitored (e.g., measured) before the cell is allowed to be a candidate for selection and/or reselection. Thus, the UE 115 may prevent establishment of a connection with a cell that does not support voice calls until after a connection has been established with a cell that does support voice calls.

In other cases, the UE 115 may prevent connection to a cell that does not support voice calls by ignoring instructions from the network to connect to the cell. For example, the UE 115 may receive a redirection message (e.g., an RRC connection release message with a redirection indication corresponding to the cell that does not support voice calls), or a handover message (e.g., a PS handover message) from the network. If the UE 115 receives a redirection message while the voice call setup is in progress, the UE 115 may ignore the redirection message (e.g., the UE 115 may behave as if the redirection indication or information conveyed by the redirection message is absent). If the UE 115 receives a handover message, the UE 115 may send a handover failure message and then act as if the handover message was not received.

Irrespective of the prevention technique used, in aspects the UE 115 may continue to prevent connection to a cell that does not support CS voice calls until after the UE 115 has determined, at 330, that the voice call has ended. Subsequently, at 335, the UE 115 may lift restraints on connections to cells that do not support voice calls. That is, the UE 115 may allow itself to connect to cells that do not support voice calls. In some cases, the UE 115 may detect that another voice call is pending within a threshold amount of time that has elapsed since the end of the original voice call. In such cases, the UE 115 may (e.g., using the techniques described herein) opt out of connecting to a cell that does not support voice calls (e.g., the UE 115 may not initiate or may abandon fast return to a cell that does not support voice calls).

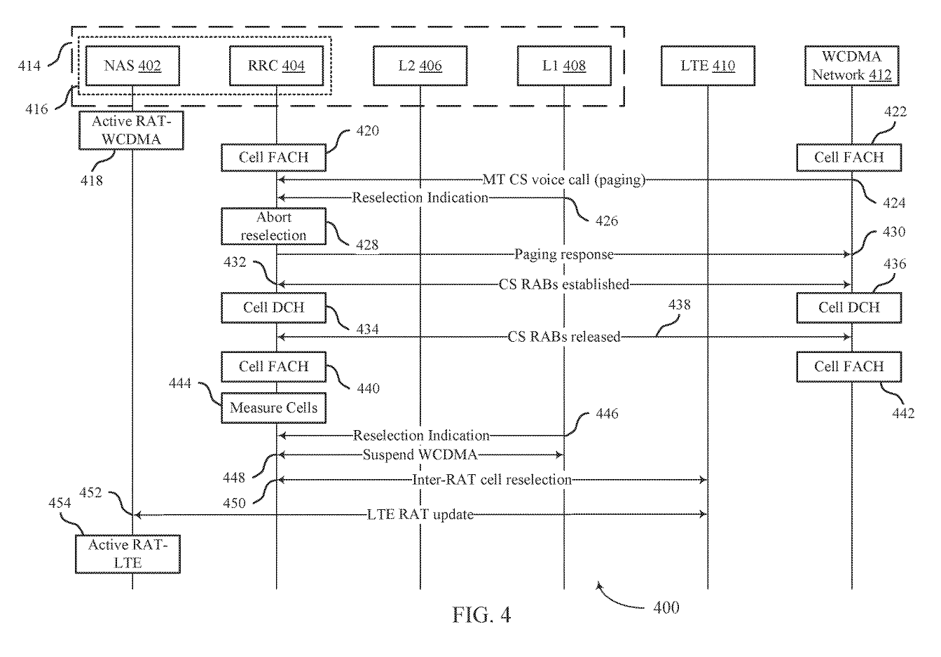

FIG. 4 illustrates an example of a process flow 400 for cell change management during voice call establishment in accordance with various aspects of the present disclosure. In some cases, process flow 400 may represent aspects of techniques performed by a UE 115 as described with reference to FIGS. 1 through 3. Process flow 400 may include actions by, and communications between, various entities. For example, process flow 400 may include an LTE network 410 and a wideband code division multiple access (WCDMA) network 412. LTE network 410 may be an example of a network that does not support voice calls and WCDMA network 412 may be an example of a network that does support voice calls. Process flow 400 may also include actions by, and communications between, various protocol stack layers. For example, process flow 400 may involve UE protocol stack layers 414, which include layer 1 (L1) 408, layer 2 (L2) 406, and layer 3 (L3) 416. Layer 3 414 may include NAS sublayer 402 and RRC sublayer 404.

NAS sublayer 402 may form the highest stratum of the control plane between the UE 115 associated with UE protocol stack layers 414 and the mobility management entity (MME) (not shown). NAS sublayer 402 may support and manage the mobility of the UE 115 and session management procedures to establish and maintain IP connectivity of the UE 115. The NAS sublayer 402 may performs aspects of authentication, registration, bearer context activation/deactivation, and location registration management. RRC sublayer 404 may be responsible for services and functions such as broadcast of system information related to the NAS and access stratum (AS), paging, quality of service (QoS) management, and mobility. RRC sublayer 404 may also be responsible for the establishment, maintenance, and release of RRC connections between the UE 115 and a network, and the establishment, configuration, maintenance, and release of RABs. RRC sublayer 404 may also be responsible for management of measurements by the UE 115 and related reporting. For example, layer 2 406 may include a MAC sublayer, RLC sublayer, and packet data convergence protocol (PDCP) sublayer, and may be responsible for, or facilitate aspects of, hybrid automatic repeat request (HARD) processes, security, header-compression, segmentation, reassembly, data multiplexing, and uplink and downlink scheduling. Finally, layer 1 408, which may also be referred to as the physical (PHY) layer, may be responsible for carrying information from other layers over the air interface. Layer 1 408 may facilitate or support aspects of power control, cell search (e.g., for initial synchronization and handover purposes), and various measurements (e.g., for the RRC sublayer 404).

At 418, NAS sublayer 402 may have an active connection with the WCDMA network 412 (e.g., the UE 115 may be in RRC connected mode with the WCDMA network 412). Specifically, the RRC sublayer 404 may be in FACH state 420 and the WCDMA network 412 may be in FACH state 422. At 424, the WCDMA network 412 may send signaling to the RRC sublayer 404 indicating that a mobile terminated circuit switched voice call is pending for the UE 115 (e.g., the WCDMA network 412 may page the UE 115). At 426, layer 1 408 may signal a reselection indication to RRC sublayer 404 that indicates the UE 115 is to perform a reselection to the LTE network 410. The reselection indication may be sent before the UE 115 recognizes that the MT CS voice call is in the process of being setup (e.g., the UE 115 may determine that RABs have not yet been assigned to the UE 115 for the MT CS voice call). At 428, the UE 115 may recognize that the MT CS voice call setup is in progress and decide to abort the reselection process. The UE 115 may abort the reselection process using any of the prevention techniques described here; thus, UE 115 may prevent connection to a cell that does not support CS voice calls while the CS voice call is being setup. The prevention may be based on the determination that the CS voice call is in progress and on the determination that the LTE network 410 does not support CS voice calls. At 430, the UE 115 may, via RRC sublayer 404, send a paging response to the WCDMA network.

At 432, the UE 115 may establish circuit switched RABs for the MT CS voice call between RRC sublayer 404 and the WCDMA network 412. Subsequent to the establishment of the CS RABs, the RRC sublayer 404 may enter DCH state 434 and the WCDMA network may enter DCH state 436. At 438, and after the MT CS voice call has finished, the UE 115 may release the CS RABs between the RRC sublayer 404 and the WCDMA network 512. Subsequently, the RRC sublayer 404 may enter FACH state 440 and the WCDMA network 412 may enter FACH state 442. At 444, RRC sublayer 404 may make reselection measurements of candidate cells (e.g., 2G cells, 3G cells, and cells in the LTE network 410). Based on the measurements, layer 1 404 may determine that the UE 115 should perform reselection to the LTE network 410 and send a reselection indication 446 to the RRC sublayer 404. In response to the reselection indication 446, the UE 115 may, via signaling between the RRC sublayer 404 and layer 1 408 at 448, suspend the WCDMA connection between the UE 115 and the WCDMA network 412. Subsequently at 450, the UE 115 may perform inter-RAT cell reselection via signaling between the RRC sublayer 404 and the LTE network 410. At 452, the active RAT may be updated to LTE via signaling between the NAS sublayer 402 and the LTE network 410. Accordingly, at 454, the NAS 402 may have an active connection with the LTE network 410 (e.g., the UE 115 may be in RRC connected mode with the LTE network 410).

Although described with reference to LTE and WCDMA wireless technologies, the techniques described herein may be applicable to other wireless technologies and may be implemented in any scenario in which a wireless technology camped on by a UE 115 supports voice services and another candidate wireless technology does not.

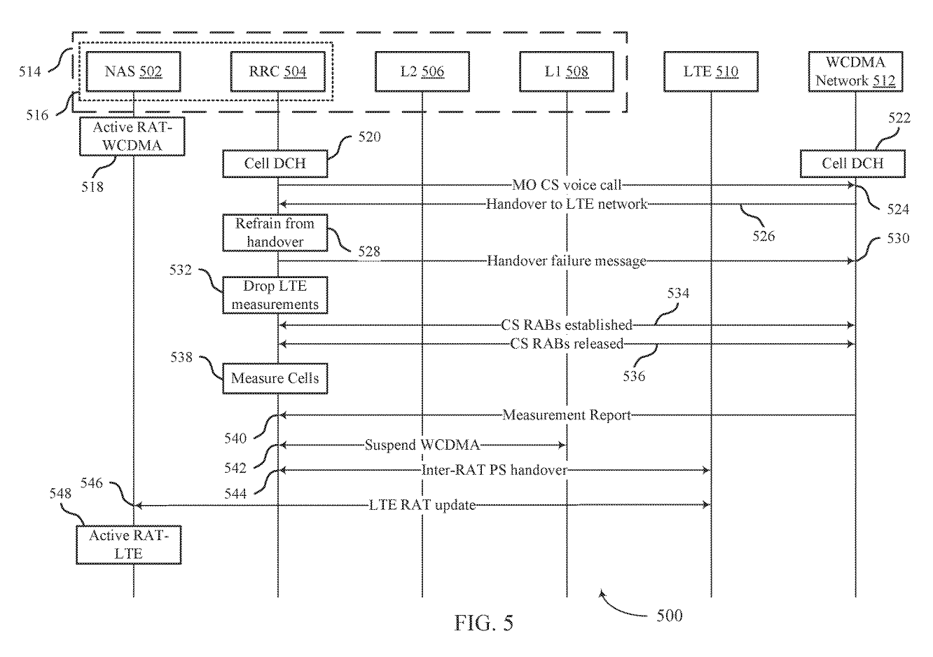

FIG. 5 illustrates an example of a process flow 500 for cell change management during voice call establishment in accordance with various aspects of the present disclosure. In some cases, process flow 500 may represent aspects of techniques performed by a UE 115 as described with reference to FIGS. 1 through 3. Process flow 500 may include actions by, and communications between, various entities. For example, process flow 500 may include an LTE network 510 and WCDMA network 512. LTE network 510 may be an example of a network that does not support voice calls and WCDMA network 512 may be an example of a network that does support voice calls. Process flow 500 may also include actions by, and communications between, various protocol stack layers. For example, process flow 500 may include UE protocol stack layers 514, which include layer 1 (L1) 508, layer 2 (L2) 506, and layer 3 (L3) 516. Layer 3 514 may include NAS sublayer 502 and RRC sublayer 504.

At 518, NAS sublayer 502 may have an active connection with the WCDMA network 512 (e.g., the UE 115 may be in RRC connected mode with the WCDMA network 512). Specifically, the RRC sublayer 504 may be in DCH state 520 and the WCDMA network 512 may be in DCH state 522. At 524, the RRC sublayer 504 may send signaling to the WCDMA network 512 indicating that an MO CS voice call is pending. At 526, the WCDMA network 512 may send a handover message to the UE 115 via signaling to the RRC sublayer 504. For example, the WCDMA network 512 may send a PS handover message to the UE 115 indicating that the UE 115 is to handover to the LTE network 510 (e.g., to a cell in the LTE network 510). The handover message may occur prior to recognition by the WCDMA network that the MO CS voice call is in the process of being setup.

At 528, the UE 115 may refrain from handing over the LTE network 510. For example, the UE 115 may behave as if the handover message was not received. Thus, the UE 115 may, during CS voice call setup, prevent establishment of a connection to a cell that does not support CS voice calls. The UE 115 may prevent such a connection based on the determination that the CS voice call is in the process of being setup. The UE 115 may prevent such a connection using the techniques described herein. In some cases, the UE 115 may send a handover failure message 530 to the WCDMA network 512 indicating that the requested handover was not implemented or successful.

At 532, the UE 115 may drop LTE measurements. For example, the UE 115 may refrain from making measurements of signals from cells in the LTE network 510. Alternatively, the UE 115 may refrain from including measurements from LTE cells in the evaluation or reporting process for reselection or handover. The UE 115 may drop the LTE measurements until after the CS voice call setup is established, or until after the CS voice call is finished. At 534, the UE 115 may establish circuit switched RABs for the MO CS voice call between RRC sublayer 504 and the WCDMA network 512. At 536, and after the MO CS voice call has finished, the UE 115 may release the CS RABs between the RRC sublayer 504 and the WCDMA network 512. At 538, RRC sublayer 504 may make measurements of candidate cells (e.g., 2G cells, 3G cells, and cells in the LTE network 510) for connection. The UE 115 may, via RRC sublayer 504, may report the measurements to the WCDMA network 512 via a measurement report 540. At 542, the UE 115 may suspend the WCDMA connection, and at 544, the UE 115 may perform an inter-RAT PS handover to the LTE network 510 (e.g., in response to a handover message from the WCDMA network 512). At 546, the active RAT may be updated to LTE via signaling between the NAS sublayer 502 and the LTE network 510. Accordingly, at 548, the NAS sublayer 502 may have an active connection with the LTE network 510 (e.g., the UE 115 may be in RRC connected mode with the LTE network 510). Thus, the UE 115 may establish a connection to a cell in the LTE network 510 after the CS voice call has terminated.

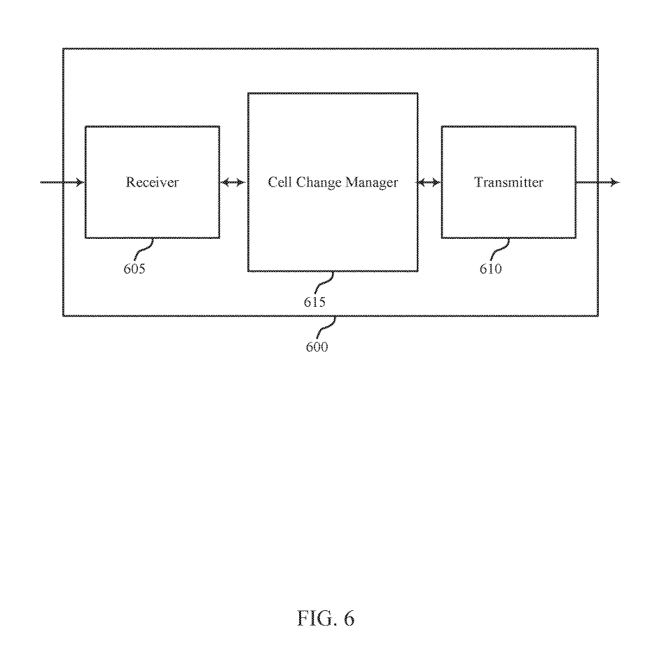

FIG. 6 shows a block diagram of a wireless device 600 that supports cell change management during voice call establishment in accordance with various aspects of the present disclosure. Wireless device 600 may be an example of aspects of a UE 115 described with reference to FIGS. 1 through 5. Wireless device 600 may include receiver 605, transmitter 610 and cell change manager 615. Wireless device 600 may also include a processor. Each of these components may be in communication with each other. Wireless device 600 may perform the connection prevention techniques described herein in various RRC states, including DCH, FACH, and PCH.

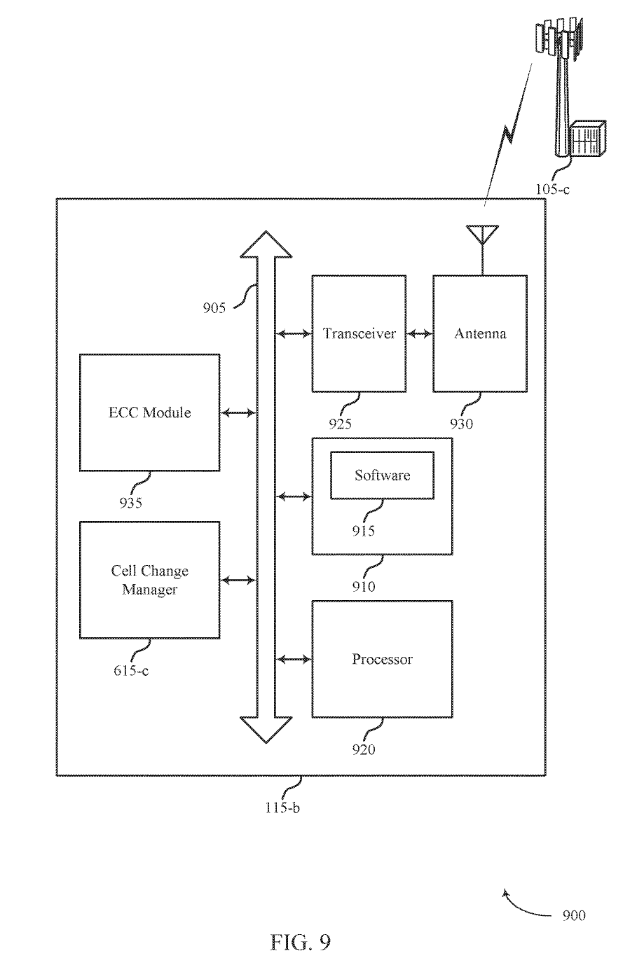

The receiver 605 may receive information such as packets, user data, or control information associated with various information channels (e.g., control channels, data channels, and information related to cell change management during voice call establishment, etc.). In some examples, the receiver 605 may receive one or more selection messages, reselection messages, handover messages and/or redirection messages. The receiver 605 may also receive, from various entities, signals upon which the wireless device 600 makes measurements (e.g., measurements for reselection, selection, redirection, and/or handover). Information may be passed on to other components of the device. The receiver 605 may be an example of aspects of the transceiver 925 described with reference to FIG. 9.

The transmitter 610 may transmit signals received from other components of wireless device 600. In some examples, the transmitter 610 may be collocated with a receiver in a transceiver module. For example, the transmitter 610 may be an example of aspects of the transceiver 925 described with reference to FIG. 9. The transmitter 610 may include a single antenna, or it may include a plurality of antennas. In some examples, the transmitter 610 may transmit measurement reports that convey measurements of signals receive by the wireless device 600. The transmitter 610 may also transmit transfer failure (e.g., handover failure) messages.

The cell change manager 615 may determine, while the wireless device 600 is in RRC idle mode or in RRC connected mode with a first cell that supports voice calls, that the wireless device 600 is to participate in a voice call setup operation. The cell change manager 615 may also determine that the wireless device 600 is to attempt to establish a connection to a second cell that does not support voice calls while the voice call setup operation is in progress. The cell change manager 615 may prevent establishment of the connection to the second cell while the voice call setup operation is in progress. The prevention may be based on voice calls being unsupported by the second cell. The cell change manager 615 may also be an example of aspects of the cell change manager 615-c described with reference to FIG. 9.

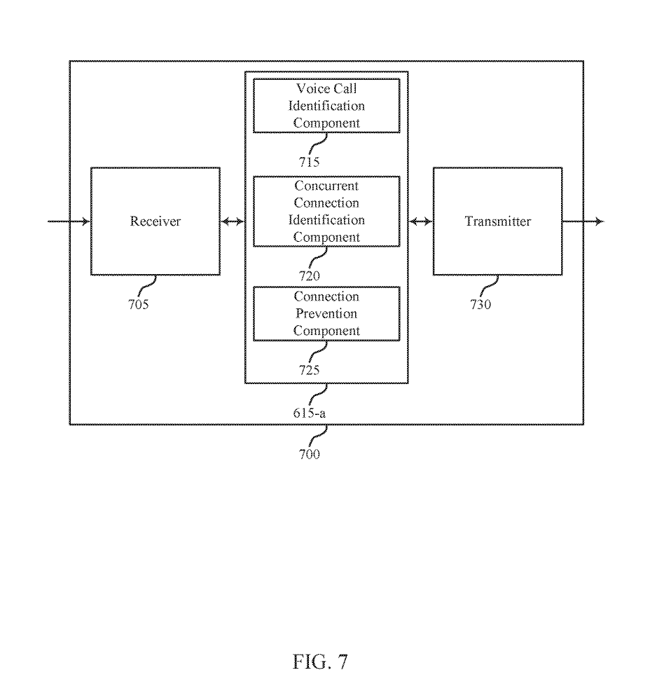

FIG. 7 shows a block diagram of a wireless device 700 that supports cell change management during voice call establishment in accordance with various aspects of the present disclosure. Wireless device 700 may be an example of aspects of a wireless device 600 or a UE 115 described with reference to FIGS. 1, 2 and 6. Wireless device 700 may include receiver 705, cell change manager 615-a and transmitter 730. Wireless device 700 may also include a processor. Each of these components may be in communication with each other.

The receiver 705 may receive information which may be passed on to other components of the device. The receiver 705 may also perform the functions described with reference to the receiver 605 of FIG. 6. The receiver 705 may be an example of aspects of the transceiver 925 described with reference to FIG. 9. The transmitter 730 may transmit signals received from other components of wireless device 700. In some examples, the transmitter 730 may be collocated with a receiver in a transceiver module. For example, the transmitter 730 may be an example of aspects of the transceiver 925 described with reference to FIG. 9. The transmitter 730 may utilize a single antenna, or it may utilize a plurality of antennas.

The cell change manager 615-a may be an example of aspects of the cell change manager 615 described with reference to FIG. 6. The cell change manager 615-a may include voice call identification component 715, concurrent connection identification component 720 and connection prevention component 725. The cell change manager 615-a may be an example of aspects of the cell change manager 615-c described with reference to FIG. 9.

The voice call identification component 715 may determine (e.g., while the wireless device 700 is in RRC idle mode or in RRC connected mode with a first cell that supports CS voice calls) that the wireless device 700 is to participate in a voice call setup operation. For example, the voice call identification component 715 may detect at least one of a pending MO or MT voice call. The concurrent connection identification component 720 may determine that the wireless device 700 is to attempt to establish a connection to a second cell that does not support voice calls while the voice call setup operation is in progress. In some cases, the voice call setup operation may include assignment and/or establishment of RABs for the voice call, although other setup operations may be included.

The connection prevention component 725 may prevent establishment of the connection to the second cell while the voice call setup operation is in progress. The prevention may be based on voice calls being unsupported by the second cell. In some cases, preventing establishment of the connection to the second cell includes preventing at least one of selection, reselection, redirection, or handover to the second cell. In some cases, preventing establishment of the connection to the second cell includes receiving (e.g., by the receiver 705), while the wireless device 700 is in an RRC connected mode, an indication to change connections from the first cell that supports CS voice calls to the second cell and refrain from changing connections. The indication to change connections may be an RRC connection release message that includes a redirection indication or a packet switched handover message. The connection prevention component 725 may refrain from changing connections. In some cases, preventing establishment of the connection to the second cell includes delaying, while the wireless device 700 is in RRC idle mode, an opportunity to transfer to (e.g., re-select to) the second cell until after a connection has been established with a cell that supports voice calls. In some cases, preventing establishment of the connection to the second cell includes updating, by the wireless device 700, one or more parameters associated with reselection to prevent establishment of the connection to the second cell until after a connection has been established with a cell that supports voice calls. In some cases, preventing establishment of the connection includes preventing the attempt to establish the connection or preventing successful completion of the attempt to establish the connection.

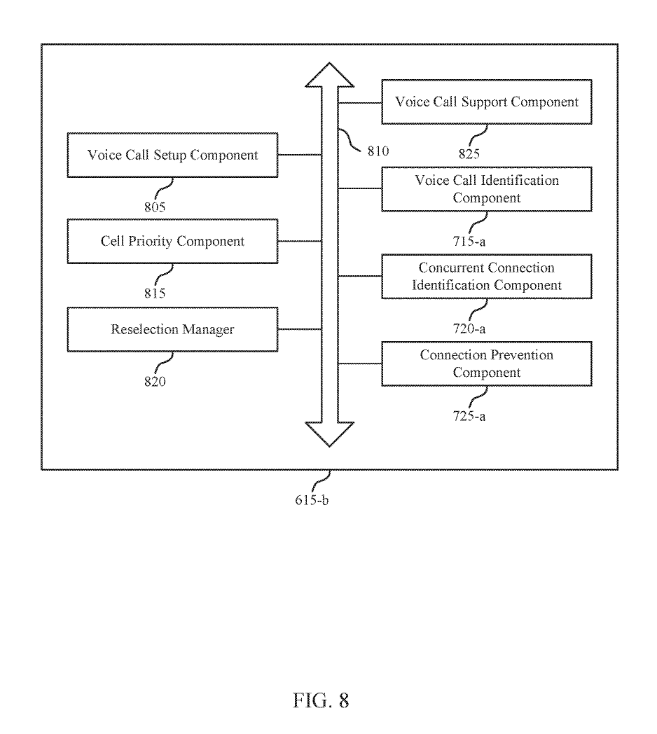

FIG. 8 shows a block diagram of a cell change manager 615-b which may be an example of the corresponding component of wireless device 600, wireless device 700, or a UE 115 in accordance with various aspects of the present disclosure. That is, cell change manager 615-b may be an example of aspects of cell change manager 615 or cell change manager 615-a described with reference to FIGS. 6 and 7. The cell change manager 615-b may also be an example of aspects of the cell change manager 615-c described with reference to FIG. 9. The UE 115 of which the cell change manager 615-b is a part may be positioned such that the UE 115 is capable of receiving service from at least two different cells. For example, the UE 115 may have the option of connecting to a first cell that supports voice calls or a second cell that does not support voice calls.

The cell change manager 615-b may include voice call setup component 805, cell priority component 815, reselection manager 820, voice call support component 825, voice call identification component 715-a, concurrent connection identification component 720-a and connection prevention component 725-a. Each of these modules may communicate, directly or indirectly, with one another (e.g., via one or more buses 810).

The voice call setup component 805 may facilitate or participate in voice call setup operations. For example, the voice call setup component 805 may participate in a voice call setup operation with the first cell that supports voice calls. The voice call setup operation may establish a connection with the first cell for the voice call. In some cases, establishment of connection to the second cell that does not support voice calls may be prevented (e.g., by the connection prevention component 725-a) until after a voice call associated with the voice call setup operation is finished. In some cases, the voice call setup component 805 may determine that RABs are assigned to the UE 115. The concurrent connection identification component 720-a may determine, prior to the determination of the RABs assignment, for example, that the UE 115 is to attempt to establish the connection to the second cell.

The cell priority component 815 may prioritize cells for transfer (e.g., selection and/or reselection). In some cases, the cell priority component 815 may assign a selection or reselection priority of the second cell to be lower than a selection or reselection priority of one or more cells (e.g., the first cell) that do support voice calls. The prioritization may be based on the determination that a voice call setup operation is in progress. The prioritization may be based on the determination on the voice call capabilities of the cells (e.g., based on the determination that the first cell supports voice calls and the second cell does not support voice calls). The prioritization may be temporary (e.g., the prioritization may be dynamically changed based on whether or not a voice call is pending). Thus, the cell priority component 815 may prevent establishment of connection to cells that do not support voice calls by prioritizing cells with voice call capabilities of cells without voice call capabilities.

The reselection manager 820 may be responsible for certain aspects of transfer (e.g., reselection), including the treatment of potential candidate cells. In some cases, the reselection manager 820 may determine whether to ignore a cell for transfer (e.g., reselection) purposes based on the voice call capabilities of the cell. For example, the reselection manager 820 may elect to perform measurements of signals of potential candidate cells that support voice calls and refrain from performing measurements of signals of cells that do not support voice calls. In other cases, the reselection manager 820 may make measurements of signals of the cells that do not support voice calls but refrain from using the measurements for transfer (e.g., reselection purposes). In some cases, the reselection manager 820 may modify, or update, a parameter associated with reselection to prevent establishment of connection to a cell that does not support voice calls. For example, the reselection manager 820 may increase the amount of time a cell that does not support voice calls is monitored before the cell is allowed to be a candidate for transfer, such as reselection. Thus, the reselection manager 820 may prevent connection to cells that do not support voice calls by delaying (e.g., while the UE 115 is in RRC idle mode) an opportunity to reselect the cells until after a connection has been established with a cell that supports voice calls.

The voice call support component 825 may determine voice call capabilities of cells. For example, the voice call support component 825 may determine whether or not a cell supports voice calls. The voice call support component 825 may further determine whether the cell supports CS voice calls or PS voice calls (e.g., via IMS or VoLTE). The connection prevention component 725-a may prevent establishment of the connection to the cell based on the determination that the cell does not support PS voice calls. For instance, the voice call support component 825 may determine that the second cell does not support PS voice calls. In such cases, the connection prevention component 725-a may prevent establishment of the connection to the second cell based on the determination that the second cell does not support PS voice calls. In some cases, determining that the second cell does not support PS voice calls may include receiving an indication of voice call capabilities of the second cell in a system information message (e.g., such as SIM). In some cases, determining that a second cell does not support CS voice calls or PS voice calls includes accessing information stored by the UE 115 that is indicative of voice call capabilities of the second cell.

The voice call identification component 715-a may determine when a voice call is pending. For example, the voice call identification component 715-a may determine (e.g., while the UE is in RRC idle mode or in RRC connected mode with the first cell) when the UE 115 is to participate in a voice call setup operation. The concurrent connection identification component 720-a may determine when a connection establishment overlap occurs or may occur; for example, the concurrent connection identification component 720-a may determine when the UE 115 is attempting to set up, or about to attempt to set up, two different connections (e.g., to two different cells) at the same time. Thus, the connection prevention component 725-a may determine when the UE 115 is to attempt to establish a connection to a second cell while the voice call setup operation is in progress.

The connection prevention component 725-a may control certain aspects of connection establishment to cells. For example, the connection prevention component 725-a may determine when a connection attempt is allowed to be initiated or completed. The connection prevention component 725-a may determine which connections are allowed to be initiated or completed based on the capabilities (e.g., the voice call capabilities) of the cell associated with the connection attempt. In some cases, the determination may be based on whether a voice call setup operation is in progress. In some examples, the connection prevention component 725-a may refrain, or cause the UE 115 to refrain, from changing connections (e.g., via handover, selection, reselection, and/or redirection).

FIG. 9 shows a diagram of a system 900 including a device that supports cell change management during voice call establishment in accordance with various aspects of the present disclosure. For example, system 900 may include UE 115-b, which may be an example of a wireless device 600, a wireless device 700, or a UE 115 as described with reference to FIGS. 1, 2 and 6 through 8.

UE 115-b may also include cell change manager 615-c, memory 910, processor 920, transceiver 925, antenna 930 and ECC module 935. Each of these modules may communicate, directly or indirectly, with one another (e.g., via one or more buses 905). The cell change manager 615-c may be an example of a cell change manager as described with reference to FIGS. 6 through 8. The memory 910 may include random access memory (RAM) and read only memory (ROM). The memory 910 may store computer-readable, computer-executable software including one or more instructions that, when executed, cause the processor to perform various functions described herein (e.g., cell change management during voice call establishment, etc.). In some cases, the software 915 may not be directly executable by the processor but may cause a computer (e.g., when compiled and executed) to perform functions described herein. The processor 920 may include an intelligent hardware device, (e.g., a central processing unit (CPU), a microcontroller, an application specific integrated circuit (ASIC), etc.).

The transceiver 925 may communicate bi-directionally, via one or more antennas, wired, or wireless links, with one or more networks, as described above. For example, the transceiver 925 may communicate bi-directionally with a base station 105 or a UE 115. The transceiver 925 may also include a modem to modulate the packets and provide the modulated packets to the antennas for transmission, and to demodulate packets received from the antennas. In some cases, the wireless device may include a single antenna 930. However, in some cases the device may have more than one antenna 930, which may be capable of concurrently transmitting or receiving multiple wireless transmissions.

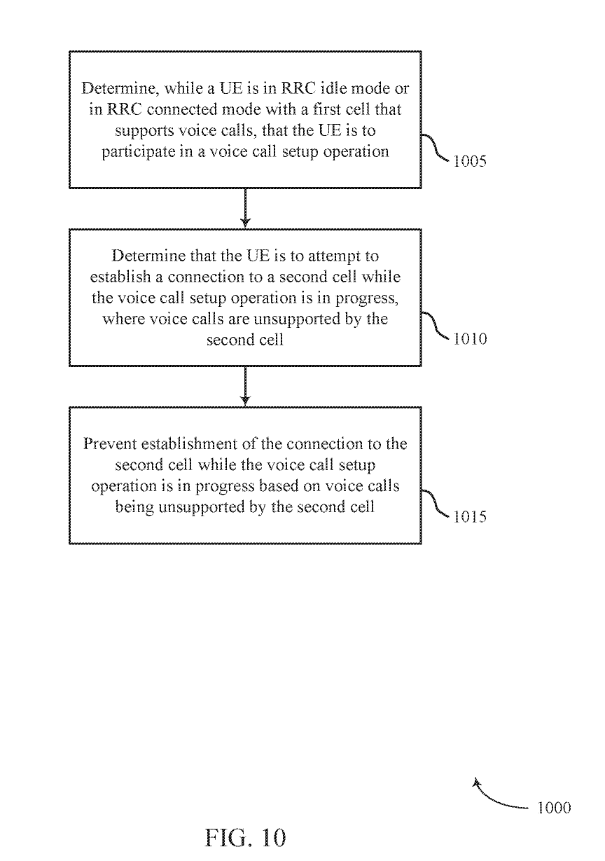

FIG. 10 shows a flowchart illustrating a method 1000 for cell change management during voice call establishment in accordance with various aspects of the present disclosure. The operations of method 1000 may be implemented by a device such as a UE 115 or its components as described with reference to FIGS. 1 and 2, or by the wireless devices of FIGS. 6-9. For example, the operations of method 1000 may be performed by the cell change manager as described herein. In some examples, the UE 115 may execute a set of one or more codes to control the functional elements of the device to perform the functions described below. Additionally or alternatively, the UE 115 may perform aspects of the functions described below using special-purpose hardware.

At block 1005, the UE 115 may determine, while the UE 115 is in RRC idle mode or in RRC connected mode with a first cell that supports voice calls, that the UE 115 is to participate in a voice call setup operation as described above with reference to FIGS. 2 through 5. In certain examples, the operations of block 1005 may be performed by the voice call identification component 715, 715-a as described with reference to FIGS. 7 and 8. At block 1010, the UE 115 may determine that the UE 115 is to attempt to establish a connection to a second cell that does not support voice calls while the voice call setup operation is in progress, as described above with reference to FIGS. 2 through 5. In certain examples, the operations of block 1010 may be performed by the concurrent connection identification component 720, 720-a as described with reference to FIGS. 7 and 8. At block 1015, the UE 115 may prevent establishment of the connection to the second cell while the voice call setup operation is in progress based on voice calls being unsupported by the second cell as described above with reference to FIGS. 2 through 5. In certain examples, the operations of block 1015 may be performed by the connection prevention component 725, 725-a as described with reference to FIGS. 7 and 8.

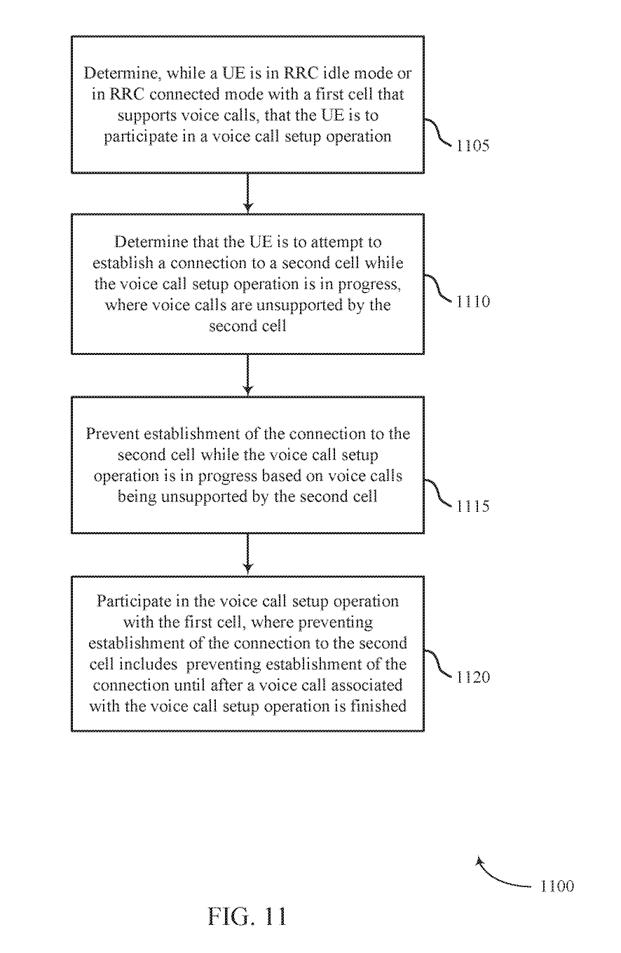

FIG. 11 shows a flowchart illustrating a method 1100 for cell change management during voice call establishment in accordance with various aspects of the present disclosure. The operations of method 1100 may be implemented by a device such as a UE 115 or its components as described with reference to FIGS. 1 and 2, or by the wireless devices of FIGS. 6-9. For example, the operations of method 1100 may be performed by the cell change manager as described herein. In some examples, the UE 115 may execute a set of one or more codes to control the functional elements of the device to perform the functions described below. Additionally or alternatively, the UE 115 may perform aspects of the functions described below using special-purpose hardware.

At block 1105, the UE 115 may determine, while the UE 115 is in RRC idle mode or in RRC connected mode with a first cell that supports voice calls, that the UE 115 is to participate in a voice call setup operation as described above with reference to FIGS. 2 through 5. In certain examples, the operations of block 1105 may be performed by the voice call identification component 715, 715-a as described with reference to FIGS. 7 and 8. At block 1110, the UE 115 may determine that the UE 115 is to attempt to establish a connection to a second cell while the voice call setup operation is in progress, where voice calls are unsupported by the second cell as described above with reference to FIGS. 2 through 5. In certain examples, the operations of block 1110 may be performed by the concurrent connection identification component 720, 720-a as described with reference to FIGS. 7 and 8.

At block 1115, the UE 115 may prevent establishment of the connection to the second cell while the CS voice call setup operation is in progress based on voice calls being unsupported by the second cell as described above with reference to FIGS. 2 through 5. In certain examples, the operations of block 1115 may be performed by the connection prevention component 725, 725-a as described with reference to FIGS. 7 and 8. At block 1120, the UE 115 may participate in the voice call setup operation with the first cell, where preventing establishment of the connection to the second cell includes preventing establishment of the connection to the second cell until after a voice call associated with the voice call setup operation is finished as described above with reference to FIGS. 2 through 5. In certain examples, the operations of block 1120 may be performed by the voice call setup component 805 as described with reference to FIG. 8.

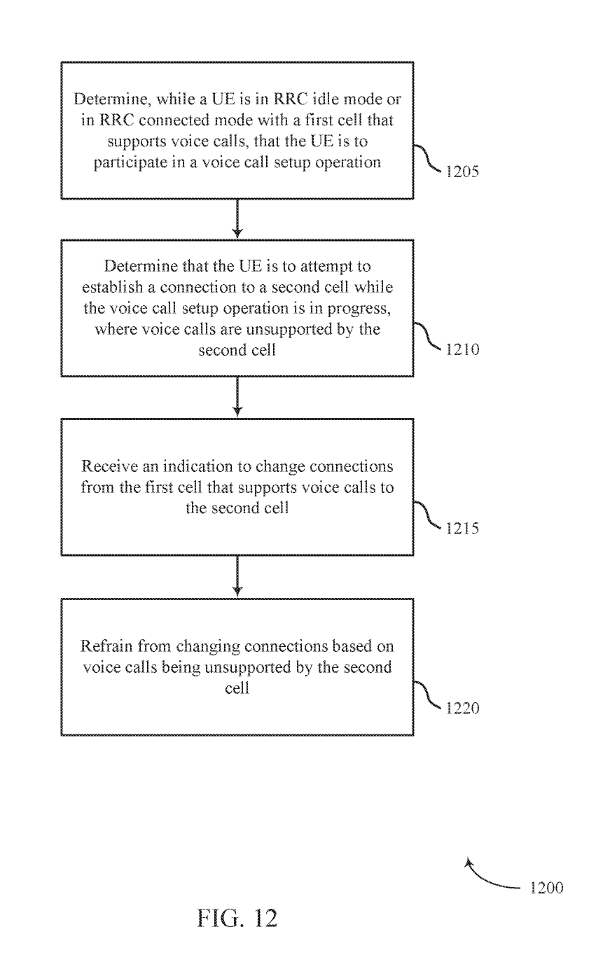

FIG. 12 shows a flowchart illustrating a method 1200 for cell change management during voice call establishment in accordance with various aspects of the present disclosure. The operations of method 1200 may be implemented by a device such as a UE 115 or its components as described with reference to FIGS. 1 and 2, or by the wireless devices of FIGS. 6-9. For example, the operations of method 1200 may be performed by the cell change manager as described herein. In some examples, the UE 115 may execute a set of one or more codes to control the functional elements of the device to perform the functions described below. Additionally or alternatively, the UE 115 may perform aspects of the functions described below using special-purpose hardware.

At block 1205, the UE 115 may determine, while the UE 115 is in RRC idle mode or in RRC connected mode with a first cell that supports CS voice calls, that the UE 115 is to participate in a voice call setup operation as described above with reference to FIGS. 2 through 5. In certain examples, the operations of block 1205 may be performed by the voice call identification component 715, 715-a as described with reference to FIGS. 7 and 8. At block 1210, the UE 115 may determine that the UE 115 is to attempt to establish a connection to a second cell while the voice call setup operation is in progress, where voice calls are unsupported by the second cell as described above with reference to FIGS. 2 through 5. In certain examples, the operations of block 1210 may be performed by the concurrent connection identification component 720, 720-a as described with reference to FIGS. 7 and 8.

At block 1215, the UE 115 may receive an indication to change connections from the first cell that supports voice calls to the second cell as described above with reference to FIGS. 2 through 5. In certain examples, the operations of block 1215 may be performed by the connection prevention component 725, 725-a as described with reference to FIGS. 7 and 8. At block 1220, the UE 115 may prevent establishment of the connection to the second cell while the voice call setup operation is in progress refraining from changing connections as described above with reference to FIGS. 2 through 5. The refraining may be based at least in part on the determination that the second cell does not support voice calls. In certain examples, the operations of block 1220 may be performed by the connection prevention component 725, 725-a as described with reference to FIGS. 7 and 8.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for cell change management during voice call establishment.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein. For example, in aspects the first cell may be an LTE cell that supports voice calls and the second cell may be an LTE cell that does not support voice calls.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “ or ” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies. In some cases, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or TDD operation (e.g., using unpaired spectrum resources). Frame structures may be defined for FDD (e.g., frame structure type 1) and TDD (e.g., frame structure type 2).

Thus, aspects of the disclosure may provide for cell change management during voice call establishment. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method for wireless communication at a user equipment (UE), comprising:
determining, while the UE is in radio resource control (RRC) idle mode or in RRC connected mode with a first cell that supports voice calls, that the UE is to participate in a voice call setup operation;
determining that the UE is to attempt to establish a connection to a second cell while the voice call setup operation is in progress, wherein voice calls are unsupported by the second cell; and
preventing, by the UE, establishment of the connection to the second cell while the voice call setup operation is in progress based at least in part on voice calls being unsupported by the second cell.

2. The method of claim 1, wherein preventing establishment of the connection comprises preventing the attempt to establish the connection or preventing successful completion of the attempt to establish the connection.

3. The method of claim 1, further comprising:
participating in the voice call setup operation with the first cell, wherein preventing establishment of the connection to the second cell includes preventing establishment of the connection to the second cell until after a voice call associated with the voice call setup operation is finished.

4. The method of claim 1, further comprising:
determining that radio access bearers (RABs) are assigned to the UE, wherein determining that the UE is to attempt to establish the connection to the second cell occurs prior to the determination of the RABs assignment.

5. The method of claim 1, wherein preventing establishment of the connection to the second cell comprises:
preventing at least one of selection, reselection, redirection, or handover to the second cell.

6. The method of claim 1, wherein preventing establishment of the connection to the second cell comprises:
receiving, while the UE is in an RRC connected mode, an indication to change connections from the first cell that supports voice calls to the second cell; and
refraining from changing connections.

7. The method of claim 6, wherein the indication to change connections comprises at least one of an RRC connection release message comprising a redirection indication or a packet switched (PS) handover message.

8. The method of claim 1, wherein preventing establishment of the connection to the second cell comprises:
assigning a selection or reselection priority of the second cell to be lower than a selection or reselection priority of one or more cells that support voice calls.

9. The method of claim 1, wherein preventing establishment of the connection to the second cell comprises:
ignoring one or more signals associated with the second cell that do not support voice calls.

10. The method of claim 9, wherein ignoring the one or more signals comprises at least one of refraining from performing measurements of the one or more signals or refraining from using measurements of the one or more signals.

11. The method of claim 1, wherein preventing establishment of the connection to the second cell comprises:
delaying, while the UE is in RRC idle mode, an opportunity to re-select the second cell until after a connection has been established with a cell that supports voice calls.

12. The method of claim 1, further comprising:
determining that packet switched (PS) voice calls are unsupported by the second cell;
wherein preventing establishment of the connection to the second cell based at least in part on voice calls being unsupported by the second cell includes preventing establishment of the connection to the second cell based at least in part on determining that PS voice calls are unsupported by the second cell.

13. The method of claim 12, wherein determining that PS voice calls are unsupported by the second cell comprises:
receiving an indication of voice call capabilities of the second cell in a system information message.

14. The method of claim 12, wherein determining that PS voice calls are unsupported by the second cell comprises:
accessing information stored by the UE, wherein the information is indicative of voice call capabilities of the second cell.

15. The method of claim 1, wherein preventing establishment of the connection to the second cell comprises:
updating, by the UE, one or more parameters associated with reselection to prevent establishment of the connection to the second cell until after a connection has been established with a cell that supports voice calls.

16. The method of claim 1, wherein a voice call corresponding to the voice call setup operation is a circuit switched (CS) voice call or a packet switched (PS) voice call.

17. A wireless communication user equipment (UE) apparatus, comprising:
means for determining, while the apparatus is in radio resource control (RRC) idle mode or in RRC connected mode with a first cell that supports voice calls, that the apparatus is to participate in a voice call setup operation;
means for determining that the apparatus is to attempt to establish a connection to a second cell while the voice call setup operation is in progress, wherein voice calls are unsupported by the second cell; and
means for preventing, by the apparatus, establishment of the connection to the second cell while the voice call setup operation is in progress based at least in part on voice calls being unsupported by the second cell.

18. The apparatus of claim 17, wherein the means for preventing establishment of the connection comprises:
means for preventing the attempt to establish the connection or preventing successful completion of the attempt to establish the connection.

19. The apparatus of claim 17, further comprising:
means for participating in the voice call setup operation with the first cell,
wherein the means for preventing establishment of the connection to the second cell includes
means for preventing establishment of the connection to the second cell until after a voice call associated with the voice call setup operation is finished.

20. The apparatus of claim 17, further comprising:
means for determining that radio access bearers (RABs) are assigned to the apparatus, wherein determining that the apparatus is to attempt to establish the connection to the second cell occurs prior to the determination of the RABs assignment.

21. The apparatus of claim 17, wherein the means for preventing establishment of the connection to the second cell comprises:
means for preventing at least one of selection, reselection, redirection, or handover (HO) to the second cell.

22. The apparatus of claim 17, wherein the means for preventing establishment of the connection to the second cell comprises:
means for receiving, while the apparatus is in an RRC connected mode, an indication to change connections from the first cell that supports voice calls to the second cell; and
means for refraining from changing connections.

23. The apparatus of claim 22, wherein the indication to change connections comprises at least one of an RRC connection release message comprising a redirection indication or a packet switched (PS) HO message.

24. The apparatus of claim 17, wherein the means for preventing establishment of the connection to the second cell comprises:
means for assigning a selection or reselection priority of the second cell to be lower than a selection or reselection priority of one or more cells that support voice calls.

25. The apparatus of claim 17, wherein the means for preventing establishment of the connection to the second cell comprises:
means for ignoring one or more signals associated with the second cell that do not support voice calls.

26. The apparatus of claim 25, wherein the means for ignoring the one or more signals comprises:
means for at least one of refraining from performing measurements of the one or more signals or refraining from using measurements of the one or more signals.

27. The apparatus of claim 17, wherein the means for preventing establishment of the connection to the second cell comprises:
means for delaying, while the apparatus is in RRC idle mode, an opportunity to re-select the second cell until after a connection has been established with a cell that supports voice calls.

28. The apparatus of claim 17, further comprising:
means for determining that PS voice calls are unsupported by the second cell,
wherein the means for preventing establishment of the connection to the second cell based at least in part on voice calls being unsupported by the second cell includes
means for preventing establishment of the connection to the second cell based at least in part on determining that PS voice calls are unsupported by the second cell.

29. The apparatus of claim 28, wherein the means for determining that PS voice calls are unsupported by the second cell comprises
means for receiving an indication of voice call capabilities of the second cell in a system information (SI) message.

30. The apparatus of claim 28, wherein the means for determining that PS voice calls are unsupported by the second cell comprises:
means for accessing information stored by the apparatus, wherein the information is indicative of voice call capabilities of the second cell.

31. The apparatus of claim 17, wherein the means for preventing establishment of the connection to the second cell comprises:
means for updating, by the apparatus, one or more parameters associated with reselection to prevent establishment of the connection to the second cell until after a connection has been established with a cell that supports voice calls.

32. The apparatus of claim 17, wherein a voice call corresponding to the voice call setup operation is a circuit switched (CS) voice call or a packet switched (PS) voice call.

33. A wireless communication user equipment (UE) apparatus, comprising:
a processor;
memory in electronic communication with the processor; and
one or more instructions stored in the memory and operable, when executed by the processor, to cause the apparatus to:
determine, while the apparatus is in radio resource control (RRC) idle mode or in RRC connected mode with a first cell that supports voice calls, that the apparatus is to participate in a voice call setup operation;
determine that the apparatus is to attempt to establish a connection to a second cell while the voice call setup operation is in progress, wherein voice calls are unsupported by the second cell; and
prevent, by the apparatus, establishment of the connection to the second cell while the voice call setup operation is in progress based at least in part on voice calls being unsupported by the second cell.

34. The apparatus of claim 33, wherein the one or more instructions operable to cause the apparatus to prevent establishment of the connection comprise one or more instructions operable to cause the apparatus to:
prevent the attempt to establish the connection or preventing successful completion of the attempt to establish the connection.

35. The apparatus of claim 33, wherein the one or more instructions are operable to cause the apparatus to:
participate in the voice call setup operation with the first cell, wherein preventing establishment of the connection to the second cell includes preventing establishment of the connection to the second cell until after a voice call associated with the voice call setup operation is finished.

36. The apparatus of claim 33, wherein the one or more instructions are operable to cause the apparatus to:
determine that radio access bearers (RABs) are assigned to the apparatus, wherein determining that the apparatus is to attempt to establish the connection to the second cell occurs prior to the determination of the RABs assignment.

37. The apparatus of claim 33, wherein the one or more instructions operable to cause the apparatus to prevent establishment of the connection comprise one or more instructions operable to cause the apparatus to:
prevent at least one of selection, reselection, redirection, or handover (HO) to the second cell.

38. The apparatus of claim 33, wherein the one or more instructions operable to cause the apparatus to prevent establishment of the connection comprise one or more instructions operable to cause the apparatus to:
receive, while the apparatus is in an RRC connected mode, an indication to change connections from the first cell that supports CS voice calls to the second cell; and
refrain from changing connections.

39. The apparatus of claim 38, wherein the indication to change connections comprises at least one of an RRC connection release message comprising a redirection indication or a packet switched (PS) HO message.

40. The apparatus of claim 33, wherein the one or more instructions operable to cause the apparatus to prevent establishment of the connection comprise one or more instructions operable to cause the apparatus to:
assign a selection or reselection priority of the second cell to be lower than a selection or reselection priority of one or more cells that support voice calls.

41. The apparatus of claim 33, wherein the one or more instructions operable to cause the apparatus to prevent establishment of the connection comprise one or more instructions operable to cause the apparatus to:
ignore one or more signals associated with the second cell that do not support voice calls.

42. The apparatus of claim 41, wherein the one or more instructions operable to cause the apparatus to ignore the one or more signals cause the apparatus to either refrain from performing measurements of the one or more signals or refrain from using measurements of the one or more signals.

43. The apparatus of claim 33, wherein the one or more instructions operable to cause the apparatus to prevent establishment of the connection comprise one or more instructions operable to cause the apparatus to:
delay, while the apparatus is in RRC idle mode, an opportunity to re-select the second cell until after a connection has been established with a cell that supports voice calls.

44. The apparatus of claim 33, wherein the one or more instructions are operable to cause the apparatus to:
determine that PS voice calls are unsupported by the second cell, wherein preventing establishment of the connection to the second cell is based at least in part on determining that PS voice calls are unsupported by the second cell.

45. The apparatus of claim 44, wherein the one or more instructions operable to cause the apparatus to determine that PS voice calls are unsupported by the second cell comprise one or more instructions operable to cause the apparatus to:
receive an indication of voice call capabilities of the second cell in a system information (SI) message.

46. The apparatus of claim 44, wherein the one or more instructions operable to cause the apparatus to determine that PS voice calls are unsupported by the second cell comprise one or more instructions operable to cause the apparatus to:
access information stored by the apparatus, wherein the information is indicative of voice call capabilities of the second cell.

47. The apparatus of claim 33, wherein the one or more instructions operable to cause the apparatus to prevent establishment of the connection comprise one or more instructions operable to cause the apparatus to:
update, by the apparatus, one or more parameters associated with reselection to prevent establishment of the connection to the second cell until after a connection has been established with a cell that supports voice calls.

48. The apparatus of claim 33, wherein a voice call corresponding to the voice call setup operation is a circuit switched (CS) voice call or a packet switched (PS) voice call.

49. A non-transitory computer-readable medium storing code for wireless communication at a user equipment (UE), the code comprising one or more instructions executable to:
determine, while the user equipment (UE) is in radio resource control (RRC) idle mode or in RRC connected mode with a first cell that supports voice calls, that the UE is to participate in a voice call setup operation;
determine that the UE is to attempt to establish a connection to a second cell while the voice call setup operation is in progress, wherein voice calls are unsupported by the second cell; and
prevent, by the UE, establishment of the connection to the second cell while the voice call setup operation is in progress based at least in part on voice calls being unsupported by the second cell.

50. The non-transitory computer-readable medium of claim 49, wherein the one or more instructions executable to prevent establishment of the connection comprise one or more instructions executable to:
prevent the attempt to establish the connection or preventing successful completion of the attempt to establish the connection.

51. The non-transitory computer-readable medium of claim 49, wherein the one or more instructions are executable to:
participate in the voice call setup operation with the first cell, wherein preventing establishment of the connection to the second cell includes preventing establishment of the connection to the second cell until after a voice call associated with the voice call setup operation is finished.

52. The non-transitory computer-readable medium of claim 49, wherein the one or more instructions are executable to:
determine that radio access bearers (RABs) are assigned to the UE, wherein determining that the UE is to attempt to establish the connection to the second cell occurs prior to the determination of the RABs assignment.

53. The non-transitory computer-readable medium of claim 49, wherein the one or more instructions executable to prevent establishment of the connection comprise one or more instructions executable to:
prevent at least one of selection, reselection, redirection, or handover (HO) to the second cell.

54. The non-transitory computer-readable medium of claim 49, wherein the one or more instructions executable to prevent establishment of the connection comprise one or more instructions executable to:
receive, while the UE is in an RRC connected mode, an indication to change connections from the first cell that supports voice calls to the second cell; and
refrain from changing connections.

55. The non-transitory computer-readable medium of claim 54, wherein the indication to change connections comprises at least one of an RRC connection release message comprising a redirection indication or a packet switched (PS) HO message.

56. The non-transitory computer-readable medium of claim 49, wherein the one or more instructions executable to prevent establishment of the connection comprise one or more instructions executable to:
assign a selection or reselection priority of the second cell to be lower than a selection or reselection priority of one or more cells that support voice calls.

57. The non-transitory computer-readable medium of claim 49, wherein the one or more instructions executable to prevent establishment of the connection comprise one or more instructions executable to:
ignore one or more signals associated with the second cell that do not support voice calls.

58. The non-transitory computer-readable medium of claim 57, wherein the one or more instructions executable to ignore the one or more signals comprise one or more instructions executable to:
refrain from performing measurements of the one or more signals or refrain from using measurements of the one or more signals.

59. The non-transitory computer-readable medium of claim 49, wherein the one or more instructions executable to prevent establishment of the connection comprise one or more instructions executable to:
delay, while the UE is in RRC idle mode, an opportunity to re-select the second cell until after a connection has been established with a cell that supports voice calls.

60. The non-transitory computer-readable medium of claim 49, wherein a voice call corresponding to the voice call setup operation is a circuit switched (CS) voice call or a packet switched (PS) voice call.

61. The non-transitory computer-readable medium of claim 49, wherein the one or more instructions are executable to:
determine that PS voice calls are unsupported by the second cell, wherein preventing establishment of the connection to the second cell is based at least in part on determining that PS voice calls are unsupported by the second cell.

62. The non-transitory computer-readable medium of claim 61, wherein the one or more instructions executable to determine that PS voice calls are unsupported by the second cell comprise instructions executable to:
receive an indication of voice call capabilities of the second cell in a system information (SI) message.

63. The non-transitory computer-readable medium of claim 61, wherein the one or more instructions executable to determine that PS voice calls are unsupported by the second cell comprise one or more instructions executable to:
access information stored by the UE, wherein the information is indicative of voice call capabilities of the second cell.

64. The non-transitory computer-readable medium of claim 49, wherein the one or more instructions executable to prevent establishment of the connection comprise one or more instructions executable to:
update, by the UE, one or more parameters associated with reselection to prevent establishment of the connection to the second cell until after a connection has been established with a cell that supports voice calls.
